(19) United States
(12) Patent Application Publication
(10) Pub. No.: US 2010/0132008 A1
(43) Pub. Date: May 27, 2010

(54) SEMICONDUCTOR INTEGRATED CIRCUIT AND VIDEO/AUDIO PROCESSING DEVICE USING THE SAME

(75) Inventor: Masahiro TAKEUCHI, Osaka (JP)

Correspondence Address: McDERMOTT WILL & EMERY LLP, 60013th Street, N.W., Washington, DC, 20005-3096, US

(73) Assignee: PANASONIC CORPORATION, Osaka (JP)

(21) Appl. No.: 12/691,397

(22) Filed: Jan. 21, 2010

Related U.S. Application Data
(63) Continuation of application No. PCT/JP2008/001465, filed on Jun. 9, 2008.

(30) Foreign Application Priority Data
Jul. 30, 2007 (JP) 2007-197227

(51) Int. Cl. H04N 7/16

(52) U.S. Cl. 725/141

(57) ABSTRACT

A program distribution unit transfers programs of a plurality of signal processing blocks input to a data input terminal of a semiconductor circuit via a path different from a loading path of a program of a CPU to respective ones of instruction memories of microcontrollers of the plurality of signal processing blocks.

### CROSS-REFERENCE TO RELATED APPLICATION

This is a continuation of PCT International Application PCT/JP2008/001465 filed on Jun. 9, 2008, which claims priority to Japanese Patent Application No. 2007-197227 filed on Jul. 30, 2007. The disclosures of these applications including the specifications, the drawings, and the claims are hereby incorporated by reference in its entirety.

### BACKGROUND

The present disclosure relates to system LSIs for digital television broadcasting, and specifically to increasing the speed of loading programs to respective ones of signal processing blocks mounted in the system LSIs and startup of the system LSIs.

In recent years, in the field of system LSIs for digital home electric apparatuses, emphasis has been placed on system on chip (SoC) in which functions required for digital home electric apparatuses are integrated in one LSI. For example, in system LSIs for receiving digital television broadcasting, a CPU required for overall controlling, a TS decoder, an AV decoder, a video output unit, an audio output unit, a peripheral interface, an external memory controller, etc. are integrated in one LSI in many cases. This reduces the cost of production compared to the case of using a plurality of integrated circuits, and thus it is possible to produce products that are more competitive.

Among the above circuit group, signal processing blocks such as the TS decoder, the AV decoder, the video output unit, the audio output unit, etc. are required to perform signal processing compliant with broadcasting systems, video/audio coding systems, etc. around the world. Controlling all the signal processing blocks by one CPU in order to realize the versatility is not realistic because the CPU requires very high performance. Therefore, a system in which signal processing blocks are each provided with a dedicated controller (also referred to as a microcontroller) is used in many cases. In this microcontroller system, a CPU sets a value in a register of each microcontroller to give an instruction to the microcontroller, and according to the given instruction, the microcontroller controls its signal processing block. In this way, desired signal processing is executed in each signal processing block.

In a conventional system LSI using the microcontroller system to receive digital television broadcasting, a program of a microprocessor is first loaded from an auxiliary memory such as a flash memory to activate the microprocessor. The activated microprocessor controls loading of a program (hereinafter also referred to as “microcode” in order to be distinguished from the program of the microprocessor) from an external memory such as a flash memory to an instruction memory of the microcontroller in each signal processing block, and then activates the microcontroller. Then, according to the microcode loaded to the instruction memory, each activated microcontroller starts predetermined signal processing. In this way, the system LSI is finally brought into a normal operation state.

### SUMMARY

In the system LSI using the microcontroller system, it is required to load the programs to the microprocessor and to each signal processing block at the time of startup of the system LSI. However, the access speed of the auxiliary memory such as a flash memory storing various programs is slower than that of a main memory such as a DRAM. Thus, the system LSI using the microcontroller system may take a relatively long time to load the programs, as a result of which quick startup is difficult.

In view of the above problems, the detailed description describes implementations of a system LSI for receiving digital television broadcasting which can be quickly started up.

An example semiconductor integrated circuit configured to input process stream data of digital television broadcasting includes: a plurality of signal processing blocks each including a microcontroller which has an instruction memory and executes a program loaded to the instruction memory to perform predetermined signal processing; a CPU configured to control the plurality of signal processing blocks; and a program distribution unit configured to transfer programs of the plurality of signal processing blocks input to a data input terminal of the semiconductor integrated circuit to respective ones of the instruction memories of the plurality of signal processing blocks. Here, the programs of the plurality of signal processing blocks are input to the data input terminal via a path different from a loading path of a program of the CPU. With this configuration, concurrently with loading of the program to activate the CPU which controls the entirety of the semiconductor integrated circuit, the programs are loaded to respective ones of the instruction memories of the microcontrollers of the signal processing blocks, so that the semiconductor integrated circuit can be quickly started up.

Specifically, the data input terminal is used as an input terminal for the stream data. Moreover, the programs are preferably input to the data input terminal as part of the stream data, and the program distribution unit analyzes the stream data input to the data input terminal, and when determining that the stream data includes a program, determines, according to a predetermined rule, to which one of the plurality of signal processing blocks the input program belongs, and transfers the input program to the instruction memory of the determined signal processing block. With this configuration, not only at the time of startup but also during normal operation of the semiconductor integrated circuit, the programs can be distributed via the data input terminal to the signal processing blocks to change signal processing systems of the signal processing blocks.

Preferably, the program distribution unit transfers the programs through at least one of a data line and a control line among the program distribution unit and the plurality of signal processing blocks. With this configuration, it is possible to prevent the increase in circuit size of the semiconductor integrated circuit.

Moreover, preferably, the microcontroller of each of the plurality of signal processing blocks includes a control register, and when determining that data input to the data input terminal includes an initial value of any of the plurality of signal processing blocks, the program distribution unit determines, according to a predetermined rule, to which one of the plurality of signal processing blocks the initial value belongs, and sets the initial value in the control register of the determined signal processing block. More preferably, when determining that the data input to the data input terminal includes an activation command of any of the plurality of signal processing blocks, the program distribution unit determines, according to a predetermined rule, to which one of the plurality of signal processing blocks the activation command belongs, and activates the determined signal processing block according to the activation command. With this configuration, without waiting for activation of the CPU, the initial value can be set in each signal processing block to activate the signal processing blocks, so that the semiconductor integrated circuit can be started up more quickly.

Moreover, preferably, the program distribution unit preferentially activates a video output unit configured to output a video signal and an audio output unit configured to output a decoded audio signal among the plurality of signal processing blocks. With this configuration, it is possible to output any video and audio before the entirety of the semiconductor integrated circuit is started up to start processing stream data.

### BRIEF DESCRIPTION OF THE DRAWINGS

FIG. 1 is a view illustrating a configuration of a video/audio processing device according to Embodiment 1.

FIG. 2 is a view illustrating a configuration of a video/audio processing device according to Embodiment 2.

FIG. 3 is a view illustrating a configuration of a video/audio processing device according to Embodiment 3.

FIG. 4 is a view illustrating a configuration of a video/audio processing device according to Embodiment 4.

FIG. 5 is a view illustrating a configuration of a video/audio processing device according to Embodiment 5.

FIG. 6 is a view illustrating a configuration of a video/audio processing device according to Embodiment 6.

FIG. 7 is a view illustrating a configuration of a video/audio processing device according to Embodiment 7.

### DETAILED DESCRIPTION OF THE INVENTION

### Embodiment 1

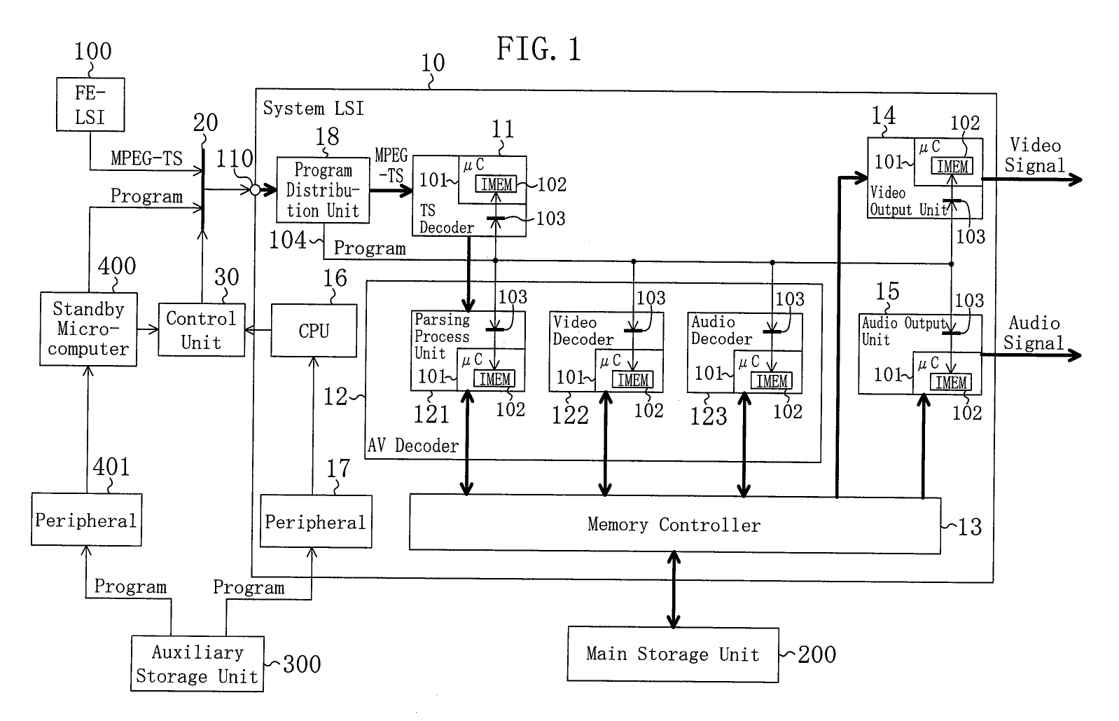

FIG. 1 illustrates a configuration of a video/audio processing device according to Embodiment 1. Thick lines in the figure indicate flows of video and audio data and signals. A TS decoder 11 accordingly splits an input MPEG-TS based on packet information, etc. to output required video and audio TS packets in streams to an AV decoder 12.

In the AV decoder 12, a parsing process unit 121 separates the input TS packets into a video stream and an audio stream (parsing process). The video stream and the audio stream after the parsing process are transferred via a memory controller 13 to a main storage unit 200 composed of a SDRAM, or the like. A video decoder 122 fetches the video stream from the main storage unit 200, and performs a variable-length coding process, an inverse quantization process, an inverse discrete cosine transform process, a motion compensation process, etc. to decode a video frame. The decoded video frame is transferred to the main storage unit 200. An audio decoder 123 fetches the audio stream from the main storage unit 200, and performs a variable-length coding process, etc. to decode audio data. The decoded audio data is transferred to the main storage unit 200.

A video output unit 14 reads the video frame from the main storage unit 200, performs a resizing process as necessary, and then superimposes an on screen display (OSD) image, and outputs a video signal in a general format. An audio output unit 15 reads the audio data from the main storage unit 200, and outputs an audio signal in a general format.

The TS decoder 11, the parsing process unit 121, the video decoder 122, the audio decoder 123, the video output unit 14, and the audio output unit 15 are signal processing blocks each having a dedicated microcontroller 101. Each of these signal processing blocks can execute desired signal processing according to a program (e.g., a microcode) loaded to an instruction memory 102 of the microcontroller 101. It is not necessary that all the signal processing blocks have the dedicated microcontrollers 101, but the plurality of signal processing blocks may share one microcontroller 101.

A CPU 16 is responsible for controlling the entirety of a system LSI 10 including the above circuit elements. A control program of the CPU 16 is loaded via a peripheral 17 from an auxiliary storage unit 300 composed of a flash memory, or the like.

A program distribution unit 18 determines whether data input to a data input terminal 110 of the system LSI 10 is an MPEG-TS or a program of each signal processing block. The determination can be made by detecting a specific pattern defined for data including the program. As the pattern, specific data strings contiguous in time, a data string including a bit string in a specific bit position, or the like can be used.

When the program distribution unit 18 determines that the input data is the MPEG-TS, the program distribution unit 18 inputs the data input to the data input terminal 110 to the TS decoder 11 without the data being changed. By contrast, when the program distribution unit 18 determines that the input data includes a program, the program distribution unit 18 further determines to which signal processing block the program belongs. The determination can also be made by detecting the specific pattern. Then, when the signal processing block to which the program is to be transferred can be determined, the program distribution unit 18 sets a switch 103 of the signal processing block serving as the transfer destination of the program to a conducting state, and writes the program through a line 104 for program distribution to the instruction memory 102 of the microcontroller 101 of the signal processing block. After completion of program distribution to all the signal processing blocks, the program distribution unit 18 stops the program distribution process to prevent erroneous determination of data input thereafter.

Outside the system LSI 10, a front end LSI (FE-LSI) 100 for receiving a broadcast wave processes a received digital television broadcasting wave to output the MPEG-TS. At the time of startup of the system LSI 10, a standby microcomputer 400 reads the program of each signal processing block in the system LSI 10 via a peripheral 401 from the auxiliary storage unit 300, and outputs the read program. Means other than the standby microcomputer 400 may read the program of each signal processing block in the system LSI 10 from the auxiliary storage unit 300, and may output the read program.

A selector 20 selectively inputs one of the outputs from the front end LSI 100 and the standby microcomputer 400 to the data input terminal 110 of the system LSI 10. A control unit 30 controls the selecting operation of the selector 20. Specifically, when the control unit 30 receives a notice of startup of the system LSI 10 from the standby microcomputer 400, the control unit 30 allows the selector 20 to select the program output from the standby microcomputer 400 so that the program is input to the data input terminal 110. After that, when the control unit 30 receives a notice of completion of program distribution to all the signal processing blocks in the system LSI 10 from the CPU 16, the control unit 30 allows the selector 20 to select the MPEG-TS output from the front end LSI 100 so that the MPEG-TS is input to the data input terminal 110. That is, to the data input terminal 110, the MPEG-TS serving as normal data is input during normal operation of the system LSI 10, and the program of each signal processing block is input at the time of startup of the system LSI 10.

As described above, in the present embodiment, at the time of startup of the system LSI 10, concurrently with loading of a control program to the CPU 16, a program is loaded to the instruction memory 102 of the microcontroller 101 in each signal processing block. That is, without waiting for completion of the loading of the program to the CPU 16, the programs can be distributed to respective ones of the signal processing blocks. Thus, the system LSI 10 can be quickly started up. For example, if it takes 100 milliseconds to initialize input/output terminals and activate the memory controller, 500 milliseconds to load the program to the CPU, and 400 milliseconds to load the programs to all the signal processing blocks, the ordinary system LSI takes 1000 milliseconds to be started up. By contrast, the system LSI 10 according to the present embodiment takes only 600 milliseconds to be started up because the programs are concurrently loaded to the CPU and to all the signal processing blocks. Thus, the effect of reducing time required for startup by about 40% is achieved.

### Embodiment 2

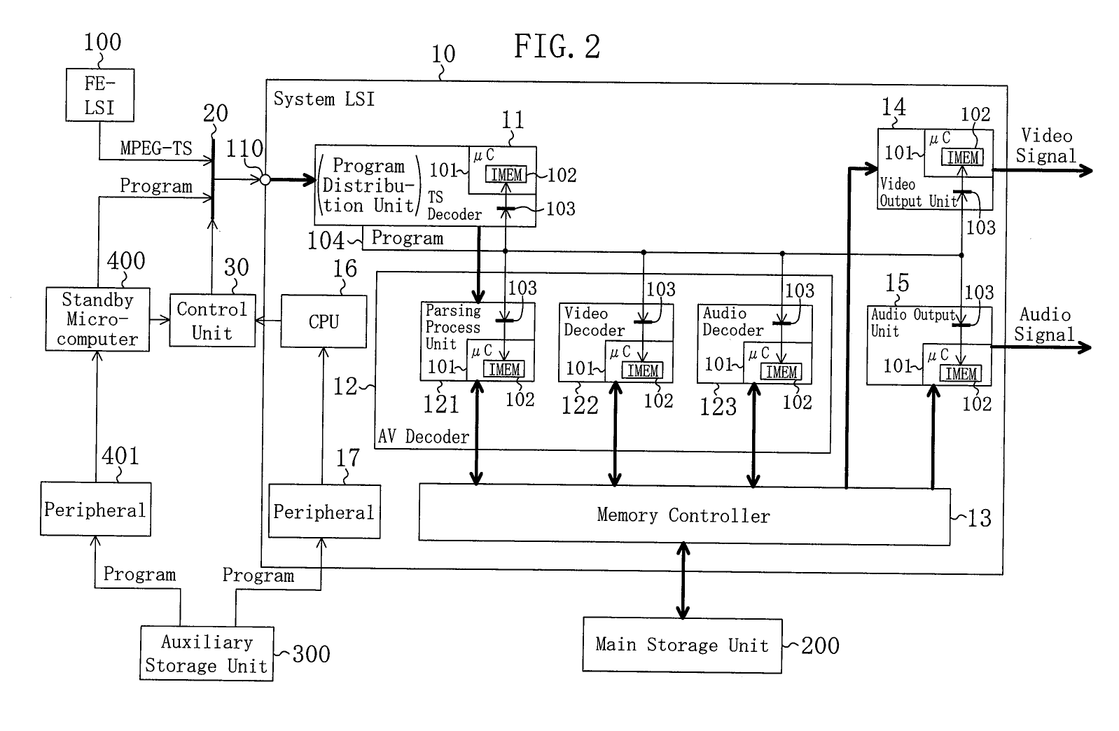

FIG. 2 illustrates a configuration of a video/audio processing device according to Embodiment 2. In the video/audio processing device according to the present embodiment, a TS decoder 11 includes the program distribution unit 18 described above. That is, the TS decoder 11 serves as a program distribution unit. Only the points different from Embodiment 1 will be described below.

In the present embodiment, programs of signal processing blocks in a system LSI 10 are input to a data input terminal 110 according to a format of an MPEG-TS. For example, the format of the MPEG-TS is extended by defining a TS packet header different from normal broadcast contents, or by embedding a program in a payload of a TS packet. The program of each signal processing block is input to system LSI 10 as stream data in the extended format.

The TS decoder 11 determines whether the input stream data is an MPEG-TS or is data including a program. When the TS decoder 11 determines that the input stream data is the MPEG-TS, the TS decoder 11 accordingly splits the MPEG-TS based on packet information to output required video and audio TS packets in streams to an AV decoder 12. By contrast, when the TS decoder 11 determines that the input stream data is stream data including the program, the TS decoder 11 determines to which signal processing block the program belongs, and transfers the program to the determined signal processing block. The determination can be made by analyzing a header of the packet or a header of data embedded in the payload in the input stream data.

As described above, in the present embodiment, even if a program of a signal processing block is input to the data input terminal 110 during normal operation of the system LSI 10, the TS decoder 11 does not erroneously process the input stream data as an MPEG-TS, but can determine that the input stream data is the program of the signal processing block to perform a program distribution process. In other words, it is possible to input a program of a signal processing block not only at the time of startup of the system LSI 10 but also during normal operation of the system LSI 10. That is, it is possible to change coding systems of video and audio during operation of the system LSI 10.

### Embodiment 3

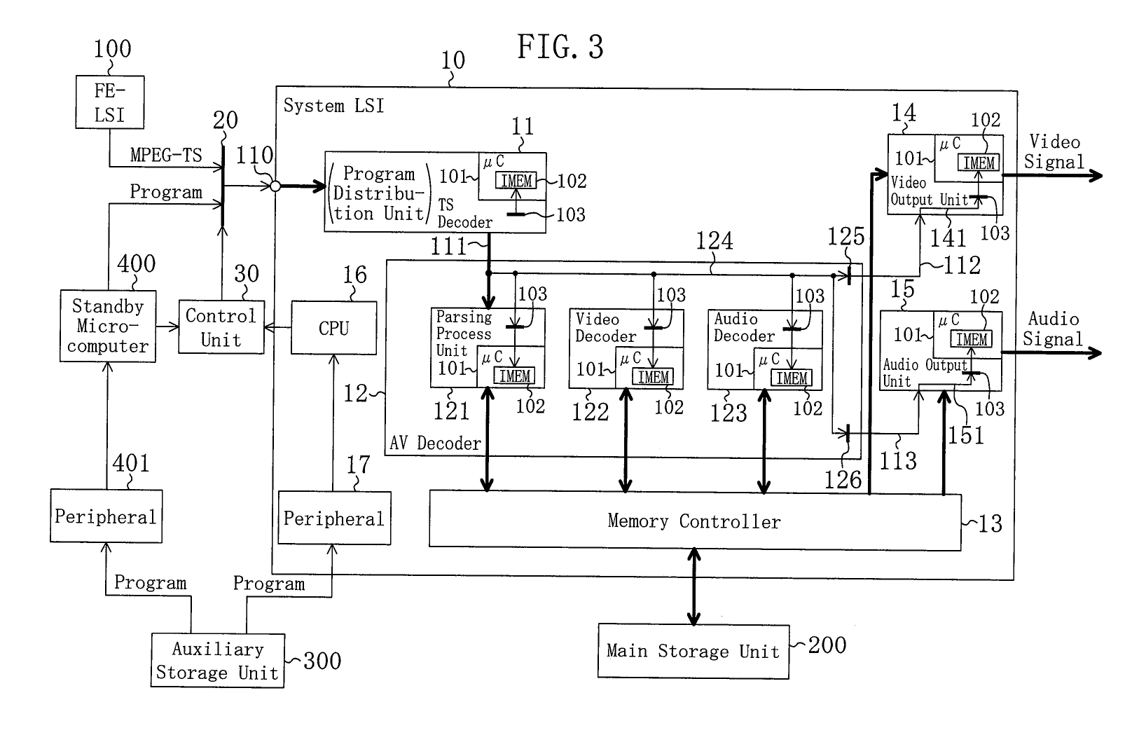

FIG. 3 illustrates a configuration of a video/audio processing device according to Embodiment 3. In the video/audio processing device according to the present embodiment, part of the system LSI 10 in the video/audio processing device of Embodiment 2 is altered such that programs of signal processing blocks are distributed through a data line 111 for sending a TS packet from a TS decoder 11 to an AV decoder 12, and through control lines 112 and 113 used for transferring control parameters from the AV decoder 12 respectively to a video output unit 14 and an audio output unit 15. Only the points different from Embodiment 2 will be described below.

When the TS decoder 11 determines that data input to a data input terminal 110 includes a program of the TS decoder 11 itself, the TS decoder 11 sets its switch 103 to a conducting state, and loads the program into an instruction memory 102 of its microcontroller 101. By contrast, when the TS decoder 11 determines that the data input to the data input terminal 110 includes a program of a signal processing block other than the TS decoder 11 itself, the TS decoder 11 sends the program to the data line 111.

If the transfer destination of the program is one of a parsing process unit 121, a video decoder 122, and an audio decoder 123, the TS decoder 11 sets a switch 103 of the related signal processing block to a conducting state, and writes the program to an instruction memory 102 of a microcontroller 101 of the signal processing block through a line 124 for program distribution in the AV decoder 12. If the transfer destination of the program is the video output unit 14, the TS decoder 11 sets a switch 125 in the AV decoder 12 and a switch 103 in the video output unit 14 to a conducting state, and writes the program to an instruction memory 102 of a microcontroller 101 of the video output unit 14 through the line 124, the control line 112, and a line 141 for program distribution in the video output unit 14. If the transfer destination of the program is the audio output unit 15, the TS decoder 11 sets a switch 126 in the AV decoder 12 and a switch 103 in the audio output unit 15 to a conducting state, and writes the program to an instruction memory 102 of a microcontroller 101 of the audio output unit 15 through the line 124, the control line 113, and a line 151 for program distribution in the audio output unit 15.

As described above, in the present embodiment, the data line 111, and the control lines 112 and 113 existing in the system LSI 10 are used for program distribution to the signal processing blocks. Therefore, in the system LSI 10, the number of new lines required for program distribution reduces, thereby reducing the circuit size. A similar effect can be achieved also by using one of the data line 111, and the control lines 112 and 113 for program distribution.

### Embodiment 4

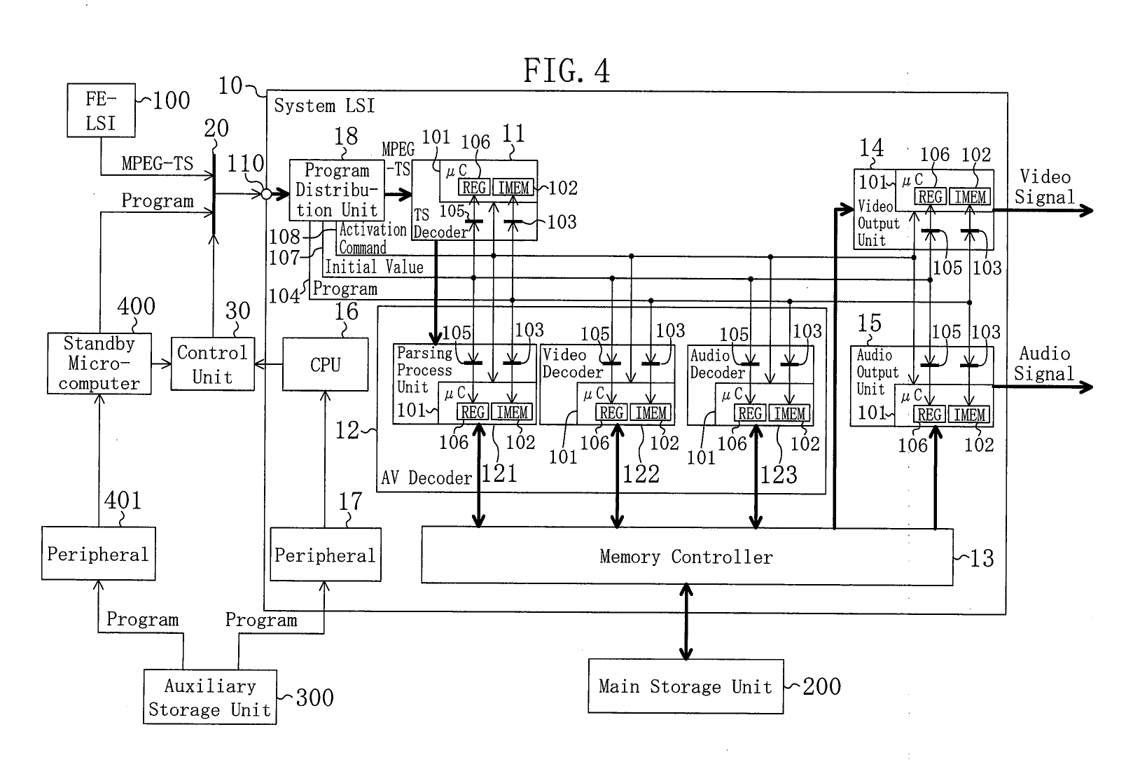

FIG. 4 illustrates a configuration of a video/audio processing device according to Embodiment 4. The video/audio processing device according to the present embodiment is developed from Embodiment 1 such that not only programs but also initial values are transferred to respective ones of signal processing blocks in a system LSI 10, and further, the signal processing blocks are activated independently of an instruction of a CPU 16. Only the points different from Embodiment 1 will be described below.

A program distribution unit 18 determines whether data input to a data input terminal 110 of the system LSI 10 is an MPEG-TS or one of a program, an initial value, and an activation command of each signal processing block.

When the program distribution unit 18 determines that the input data includes the initial value of any of the plurality of signal processing blocks, the program distribution unit 18 further determines to which signal processing block the initial value belongs. Then, when the signal processing block in which the initial value is to be set can be determined, the program distribution unit 18 sets a switch 105 of the determined signal processing block to a conducting state, and sets the initial value in a control register 106 of a microcontroller 101 of the signal processing block through a line 107 for initial value setting. Moreover, when the program distribution unit 18 determines that the input data includes the activation command of each signal processing block, the program distribution unit 18 sends the activation command to the microcontroller 101 of each signal processing block through a line 108 to control its activation.

Preferably, a video output unit 14 and an audio output unit 15 are preferentially activated. This allows any video and audio to be output before the entirety of the system LSI 10 is started up to start processing stream data.

As described above, in the present embodiment, the signal processing blocks in the system LSI 10 can be started up without waiting for the activation of the CPU 16. Thus, it is possible to reduce the time required to output a video signal and an audio signal after the system LSI 10 starts processing the stream data.

Note that a similar effect can be achieved also by setting initial values in and outputting activation commands to some of the signal processing blocks. Moreover, the program distribution unit 18 may only transfer a program to and set an initial value in each signal processing block, and the CPU 16 may activate each signal processing block. In this way, it is also possible to set the initial value in each signal processing block without waiting for the activation of the CPU 16. Thus, the system LSI 10 can be started up more quickly.

Moreover, as in the case of Embodiment 2 or Embodiment 3, the TS decoder 11 may have a program distribution function, and may further have an initial value setting function and an activation command function. In this case, the initial value and the activation command of each signal processing block are input to the data input terminal 110 as stream data according to a format of the MPEG-TS.

### Embodiment 5

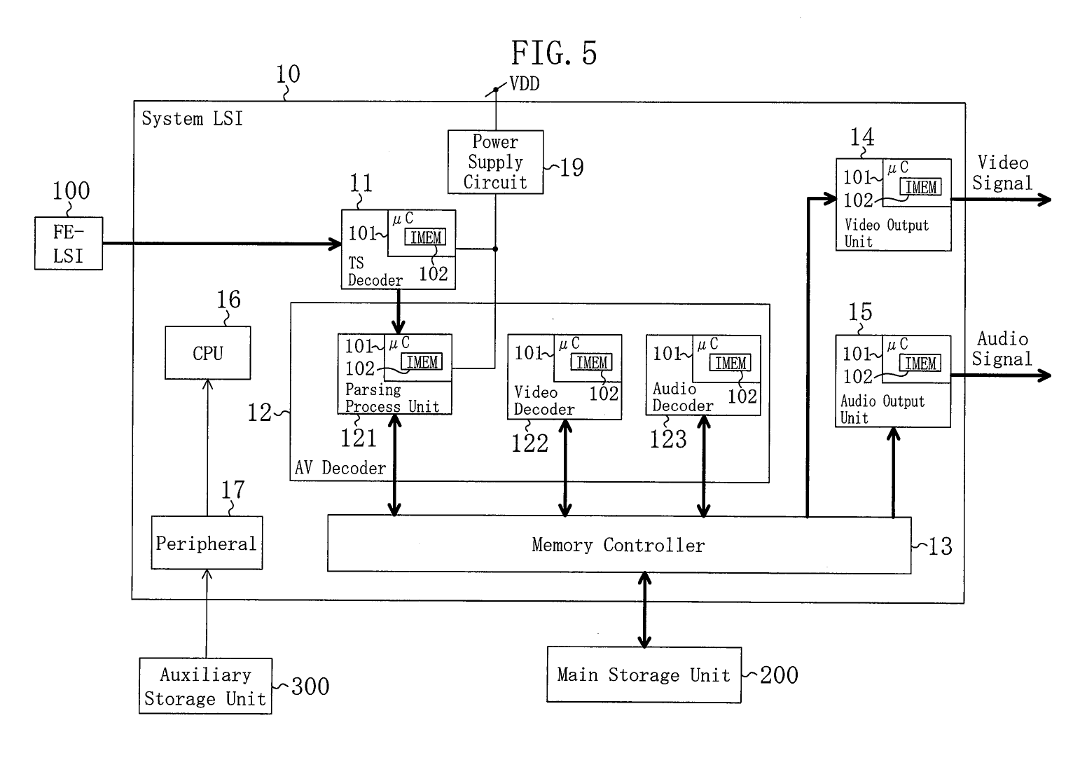

FIG. 5 illustrates a configuration of a video/audio processing device according to Embodiment 5. The video/audio processing device according to the present embodiment is configured such that a circuit for program distribution to the signal processing blocks is omitted from the video/audio processing device of Embodiment 1, and a power supply circuit 19 is added to the system LSI 10 of Embodiment 1. Only the different points from Embodiment 1 will be described below.

The power supply circuit 19 controls power supply to a TS decoder 11 and to a parsing process unit 121 independently of power supply to the system LSI 10. That is, even if the power supply to the system LSI 10 is stopped, power is supplied to the TS decoder 11 and to the parsing process unit 121, so that these signal processing blocks continue operating. Thus, even if the system LSI 10 is brought into an inactive state, part of stream processing can be continued. When the system LSI 10 resume operating, programs are loaded through the control of a CPU 16 to a video decoder 122, an audio decoder 123, a video output unit 14, and an audio output unit 15 other than the TS decoder 11 and the parsing process unit 121, and thus these signal processing blocks are activated.

As described above, in the present embodiment, even if the system LSI 10 is brought into an inactive state, the TS decoder 11 and the parsing process unit 121 continue operating. In this way, the system LSI 10 can be quickly started up. For example, if a stream input process takes 100 milliseconds, a stream parsing process takes 200 milliseconds, a video decoding process takes 600 milliseconds, and a video output process takes 400 milliseconds, it takes 1300 milliseconds for the ordinary system LSI to be started up. By contrast, in the present embodiment, since the stream input process and the stream parsing process have been operating, it takes only 1000 milliseconds for startup of the system LSI 10. Thus, the effect of reducing time required for startup by about 25% is achieved.

Note that the power supply circuit 19 can control power supply to an arbitrary signal processing block, but in terms of an increase in power consumption, it is not preferable to allow a signal processing block such as the video decoder 122 consuming a large amount of electric power to continue operating while the system LSI 10 is in an inactive state. Therefore, only the signal processing blocks such as the TS decoder 11 and the parsing process unit 121 consuming less electric power are allowed to continue operating. Of course, allowing only the TS decoder 11 to continue operating can also achieve the above effect.

### Embodiment 6

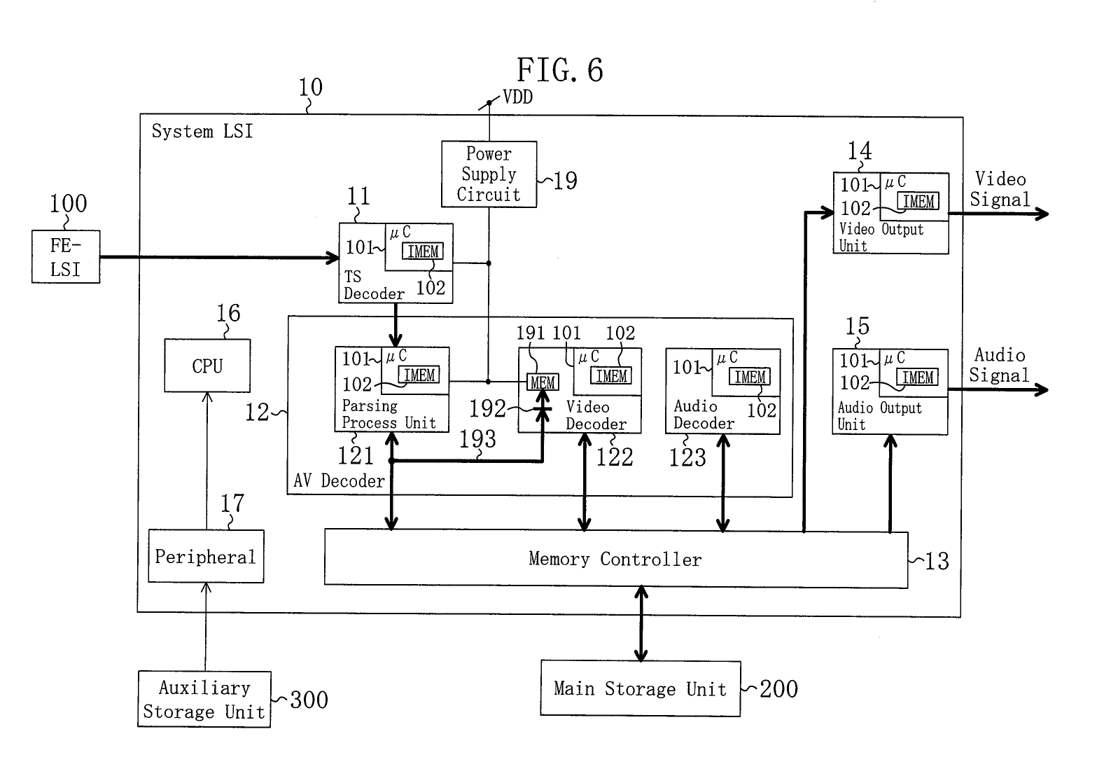

FIG. 6 illustrates a configuration of a video/audio processing device according to Embodiment 6. The video/audio processing device according to the present embodiment is configured to be able to write output data of a parsing process unit 121 directly to an internal memory 191 of a video decoder 122 without the output data being passed through a main storage unit 200. Only the points different from Embodiment 5 will be described below.

The video decoder 122 generally includes a high-speed, high-capacity internal memory 191 composed of an SRAM, or the like as an internal buffer for a decoding process. The power supply circuit 19 controls power supply to the internal memory 191 of the video decoder 122 in addition to the TS decoder 11 and the parsing process unit 121 independently of power supply to the system LSI 10. That is, even if the power supply to the system LSI 10 is stopped, power is supplied to the TS decoder 11, the parsing process unit 121, and the internal memory 191 of the video decoder 122.

When the system LSI 10 is in an inactive state, the power supply circuit 19 sets a switch 192 in the video decoder 122 to a conducting state, and writes a video stream output from the parsing process unit 121 through a line 193 to the internal memory 191 of the video decoder 122. In this way, even if the system LSI 10 is in an inactive state, and thus data cannot be written to the main storage unit 200, part of stream processing is continued, and further, an obtained video stream can be temporarily stored in the internal memory 191 of the video decoder 122.

In the case where the system LSI 10 resumes operating, programs are loaded through the control of a CPU 16 to the video decoder 122, an audio decoder 123, a video output unit 14, and an audio output unit 15 other than the TS decoder 11 and the parsing process unit 121, so that these signal processing blocks are activated. The activated video decoder 122 transfers the video stream stored in the internal memory 191 via a memory controller 13 to the main storage unit 200. In this way, it is possible for the system LSI 10 to resume operating from the state in which the video stream output from the parsing process unit 121 has been transferred to the main storage unit 200.

As described above, in the present embodiment, even if the system LSI 10 is brought into an inactive state, the TS decoder 11, the parsing process unit 121, and the internal memory 191 of the video decoder 122 continue operating, and further, the video stream output from the parsing process unit 121 is temporarily stored in the internal memory of the video decoder 122. Thus, the system LSI 10 can be started up more quickly. For example, the system LSI 10 of Embodiment 5 takes 1000 milliseconds to be started up, whereas in the present embodiment, part of data required for a video decoding process is already in the main storage unit 200 at the time of startup of the system LSI 10, and thus time required for the video decoding process is slightly reduced, and the system LSI 10 can be started up in about 900 milliseconds. Thus, the effect of reducing time required for startup by 30% compared to the ordinary embodiment is achieved.

Note that the video output unit 14 and the other signal processing blocks also have relatively high-capacity internal memories. Therefore, their internal memories may be used alternatively or additionally to the internal memory 191 of the video decoder 122.

### Embodiment 7

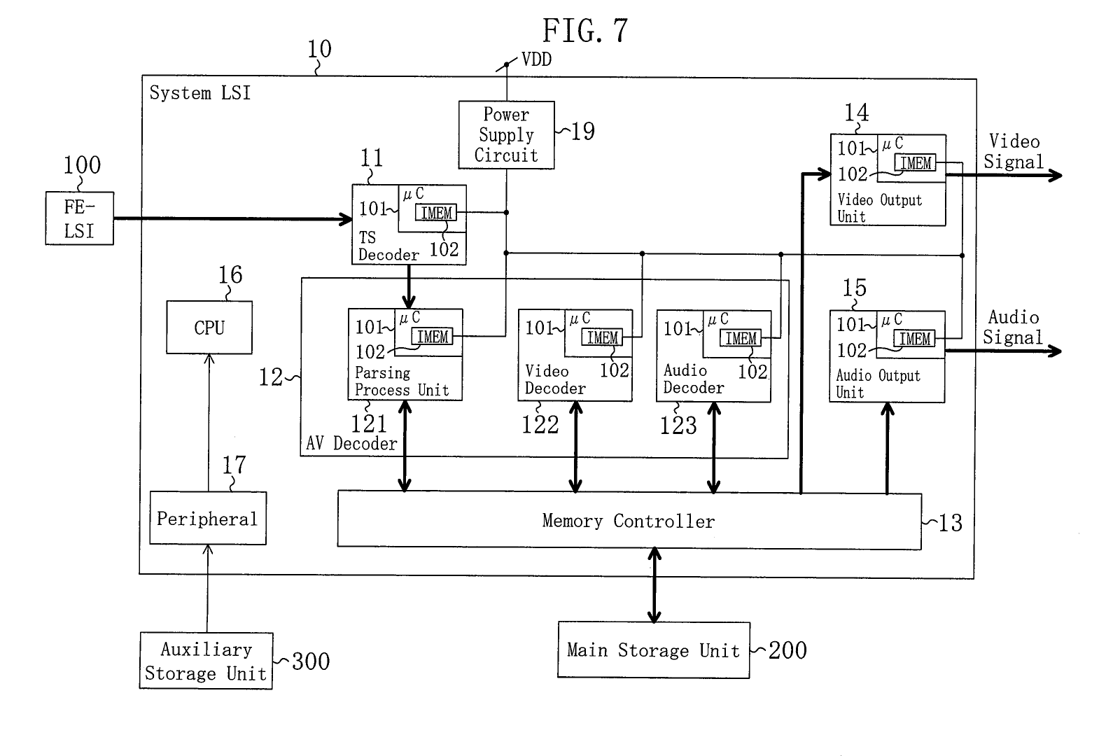

FIG. 7 illustrates a configuration of a video/audio processing device according to Embodiment 7. In the video/audio processing device according to the present embodiment, power supply is controlled individually for instruction memories 102 of microcontrollers 101 of signal processing blocks. Only the points different from Embodiment 5 will be described below.

A power supply circuit 19 controls power supply to the instruction memory 102 of the microcontroller 101 of each signal processing block independently of power supply to a system LSI 10. That is, even if the power supply to the system LSI 10 is stopped, power is supplied to the instruction memory 102 in each signal processing block, and thus the instruction memory 102 continues holding a program of each signal processing block. In this way, when the system LSI 10 resumes operating, there is no need to load the program of each signal processing block. Thus, the system LSI 10 can be quickly started up. Note that the power consumption in the instruction memory 102 in each signal processing block is very low, and thus an increase in power consumption is not perceived as a problem.

Although the above embodiments are targeted at a system to receive digital television broadcasting in which an MPEG-TS is input to the system LSI 10, the present invention is not limited to the MPEG-TS. For example, in the case of a digital video recorder, stream data including video and audio data is input to the system LSI. In this case, as a data input terminal, an IEEE1394 terminal, a USB terminal, a hard disk interface terminal, etc. can be used.

In future, a signal processing block realizing a new function may be mounted on the system LSI 10, but the system LSI 10 can be quickly started up by distributing programs and/or individually controlling power to the signal processing blocks as described above.

What is claimed is:

1. A semiconductor integrated circuit configured to process input stream data of digital television broadcasting comprising:
a plurality of signal processing blocks each including a microcontroller which has an instruction memory and executes a program loaded to the instruction memory to perform predetermined signal processing;
a CPU configured to control the plurality of signal processing blocks; and
a program distribution unit configured to transfer programs of the plurality of signal processing blocks input to a data input terminal of the semiconductor integrated circuit to respective ones of the instruction memories of the plurality of signal processing blocks, wherein
the programs of the plurality of signal processing blocks are input to the data input terminal via a path different from a loading path of a program of the CPU.

2. The semiconductor integrated circuit of claim 1, wherein
the data input terminal is used as an input terminal for the stream data.

3. The semiconductor integrated circuit of claim 2, wherein
the programs are input to the data input terminal as part of the stream data, and
the program distribution unit analyzes the stream data input to the data input terminal, and when determining that the stream data includes a program, determines, according to a predetermined rule, to which one of the plurality of signal processing blocks the input program belongs, and transfers the input program to the instruction memory of the determined signal processing block.

4. The semiconductor integrated circuit of claim 1, wherein
the program distribution unit transfers the programs through at least one of a data line and a control line among the program distribution unit and the plurality of signal processing blocks.

5. The semiconductor integrated circuit of claim 1, wherein
the microcontroller of each of the plurality of signal processing blocks includes a control register, and
when determining that data input to the data input terminal includes an initial value of any of the plurality of signal processing blocks, the program distribution unit determines, according to a predetermined rule, to which one of the plurality of signal processing blocks the initial value belongs, and sets the initial value in the control register of the determined signal processing block.

6. The semiconductor integrated circuit of claim 5, wherein
when determining that the data input to the data input terminal includes an activation command of any of the plurality of signal processing blocks, the program distribution unit determines, according to a predetermined rule, to which one of the plurality of signal processing blocks the activation command belongs, and activates the determined signal processing block according to the activation command.

7. The semiconductor integrated circuit of claim 6, wherein
the program distribution unit preferentially activates a video output unit configured to output a video signal and an audio output unit configured to output a decoded audio signal among the plurality of signal processing blocks.

8. A video/audio signal processing device of digital television broadcasting comprising:
the semiconductor integrated circuit of claim 1;
a selector configured to selectively input one of normal data which is to be input to the data input terminal and the programs of the signal processing blocks in the semiconductor integrated circuit to the data input terminal of the semiconductor integrated circuit; and
a control unit configured to control the selector to select the programs at the time of startup of the device, and then to select the normal data.
